(19) United States
(12) Patent Application Publication
(10) Pub. No.: US 2017/0345106 A1
(43) Pub. Date: Nov. 30, 2017

(54) PRODUCT PRE-PURCHASE AND STORAGE METHODS

(71) Applicant: JOSEPH SHIMONOV, CALGARY (CA)

(72) Inventor: JOSEPH SHIMONOV, CALGARY (CA)

(21) Appl. No.: 15/168,184

(22) Filed: May 30, 2016

(51) Int. Cl. G06Q 50/06; G06Q 20/28

(52) U.S. Cl. CPC G06Q 50/06; G06Q 20/28

(57) ABSTRACT

A product pre-purchase and storage method including the steps of a consumer locating a seller of a product, the consumer purchasing a quantity of product, the quantity of the product having a plurality of incremental-portions, from the seller at an initial-price, the consumer having the option of taking possession of one of the incremental-portions of the quantity of product, the consumer providing one of the incremental-portion of the quantity of product to a storage-owner, the storage-owner storing the incremental-portion of the quantity of product provided by the consumer, the storage-owner charging the consumer a storage-rate to store an incremental-portion of the quantity of product for a storage-term, and the consumer returning to optionally take possession one or more incremental-portions of the quantity of product from the storage-owner at a later time. Each transaction includes one or more transaction-fees.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of sales and purchasing and more specifically relates to product pre-purchase and storage methods.

### 2. Description of Related Art

In Canada alone there are approximately 11,500 retail fueling locations. Generally such locations have anywhere between 2 or 3 storage tanks (averaging 80,000 liters each) that are used to store different grades of gasoline and diesel fuel for fuel customers to purchase. Based on deliveries and average tank levels, this equates to over 2.5 billion liters of total storage that retailers of fuel are not fully utilizing.

Retailers purchase gasoline/diesel product at a contracted ‘rack’ price from fuel producers. Prices for these products are correlated to the pricing of upstream commodities and are therefore volatile and change frequently even over the course of a single day. Retailers offer product at a “posted” price (displayed at the retailer's physical location), that accounts for the rack price, fuel taxes and retailer's margin on a daily basis to their customers. In order to motivate customer loyalty, many programs have been introduced that give customers discounts on fuels, or points earnings on fuel—however all such programs are currently based on the daily posted price.

One of the major factors influencing when and where customers purchase of fuel is the price. Customers are generally limited by the storage capacity of the vehicle which they ‘drive-in’ with when fueling at a retail location, especially when taking advantage of low fuel-price environments, or seeking to stabilize prices. Today, no convenient way exists for fuel retailers to offer the storage available at their locations to fuel customers so that customers can purchase more fuel than they have storage for. Additionally, in doing so, retailers have the opportunity to improve their profits by optimizing their available storage capacity. Therefore a suitable solution is desired.

Several attempts have been made to solve the above-mentioned problems such as those found in U.S. and Foreign Pat. and Pub. Nos. U.S. Pat. No. 8,185,449 to Ward; U.S. Pat. No. 8,346,616 to Hwang; U.S. Pat. No. 7,292,993 and U.S. 2008/0243648 to Uzzo et al.; U.S. 2009/0307098 to Verona; U.S. 2008/0195432 to Fell et al.; U.S. 2009/0070254 to Thrush; U.S. 2013/0198074 to Cox et al.; 2013/0041795 to Baratz; and EP 2343680 to Shulz. This art is representative of sales and purchasing. However, none of the above inventions and patents, taken either singly or in combination, is seen to describe the invention as claimed.

Preferably, a product pre-purchase and storage method should provide a way for a retailer of a product, hereby the “seller”, to conveniently and profitably optimize the the utilization of owned storage capacity while providing customers of the product, hereby the “consumers” the option and/or ability to purchase the product directly, and/or exercise an option to store the product at the seller's location where the seller's storage is available at a set storage rate for an associated storage term. Thus, a need exists for reliable product pre-purchase and storage method(s) to avoid the above-mentioned problems.

### BRIEF SUMMARY OF THE INVENTION

In view of the foregoing disadvantages inherent in the known sales and purchasing art, the present disclosure provides novel product pre-purchase and storage methods. The general purpose of the present invention, which will be described subsequently in greater detail, is to provide a system and method to allow consumers of a product with an additional option to purchase a seller's available storage capacity for that product, where the seller sets a posted storage-rate and storage-term based on optimizing the utilization of seller's storage assets.

A product pre-purchase and storage method is disclosed herein, in a preferred embodiment. The preferred embodiment may include the steps of: a consumer locating a seller of a product; the consumer purchasing a quantity of product, the quantity of the product comprising a plurality of incremental-portions from the seller at an initial-price; the consumer having the option of taking possession of one of the incremental-portions of the quantity of product; the consumer exercising option to store one of the incremental-portions of the quantity of product into a “storage-owner's” available storage assets for an agreed to storage-rate and storage-term that is set by the storage owner; the storage-owner storing the incremental-portion of the quantity of product provided by the consumer for the agreed to storage-term; and the consumer returning to optionally take possession of one or more incremental-portions of the quantity of product from the storage-owner on or before the end of the storage term. Each transaction may include one or more transaction-fees.

The storage-rate is set by the storage-owner for the storage-term and, preferably, the storage-rate is based on a value of currency for a time interval for a determined quantity of product. The storage-owner may use any methods or determinations in order to set the storage-term and storage-rate. It must be noted that, given a particular product, three factors must be used to provide the storage-rate: the time interval that any of consumers' incremental portions will occupy storage-owners available storage assets (storage-term), the quantity of product to be stored (storage-amount), and the cost to store per single unit of product for that time interval (storage-rate).

In the preferred embodiment, the storage-rate, storage-term and the “spo”-price (the physical value of the process at any given time) for any product are provided to the consumer, at the seller's physical location or can be accessed remotely by the consumer, seller and the storage-owner. Additionally, the quantity of the product can be purchased and stored by the consumer from the seller and storage-owner at the physical location where the product is stored or from a remote-location, such that the consumer need not be present at a particular location to purchase and/or store product at a given storage-rate and storage-term.

In the preferred embodiment, the seller and the storage-owner are the same entity. It must be noted that during the event of the consumer purchasing the quantity of product from the seller, the initial-price for the product is equal to the spot-price. The spot-price may fluctuate during the storage-term and the spot-price may fluctuate during the storage term.

Preferably, the product is a fuel, but may comprise other goods (e.g., minerals, natural resources, agricultural goods, water, consumer products, durable goods, etc.) or comprise intangibles (e.g., computer-readable data, stocks and bonds, electricity, solar power, storable forms of energy, etc.).

The preferred embodiment includes an application to facilitate the sale of the product by locating the seller of the product. Preferably, the application further provides the consumer with information related to the initial-price, the storage-rate and associated storage-term. The application preferably displays related-information, the related-information comprising the incremental-portions of product which have been purchased by the consumer, the incremental-portions which have been credited to the storage-owner for storage (from the consumer), and the incremental-portions which have been sold back to the storage-owner at the spot-price if the consumer chooses to not renew their option to store remaining product for an extended storage-term at a recalculated storage rate. The related information may additionally include one or more transaction-fees (and/or credits, etc.) and the storage rate, and may also provide rankings for multiple storage-owners based upon (but not limited to) the related-information. The rankings may aid in the consumer selecting a seller and/or a storage-owner based on a variety of factors.

The present invention holds significant improvements and serves as product pre-purchase and storage methods. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein, without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, product pre-purchase and storage methods, constructed and operative according to the teachings of the present invention.

FIG. 1 is a flowchart illustrating a method of use for product pre-purchase and storage methods according to an embodiment of the present invention.

FIG. 2 is a diagram illustrating the product pre-purchase and storage methods according to an embodiment of the present invention of FIG. 1.

FIG. 3A illustrates an application operable by the computer system of a vehicle for product pre-purchase and storage methods according to an embodiment of the present invention of FIGS. 1-2.

FIG. 3B illustrates the application operable by a mobile phone for product pre-purchase and storage methods according to an embodiment of the present invention of FIGS. 1-3A.

FIG. 3C illustrates the application operable by a desktop computer for product pre-purchase and storage methods according to an embodiment of the present invention of FIGS. 1-3B.

FIG. 4 illustrates a decision tree for purchase and storage of fuel related to product pre-purchase and storage methods related to the purchasing and storage of product according to an embodiment of the present invention of FIGS. 1-3C.

FIG. 5 is a decision tree for account information related to product pre-purchase and storage methods related to the purchasing and retrieval of product according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a sales and purchasing, and more particularly, to a product pre-purchase and storage method, as used to improve the benefit of purchasing a product during times of lower prices, while providing a way for a retailer/seller of a product a means for maximizing available storage capacity and profits by using as much that available storage as possible.

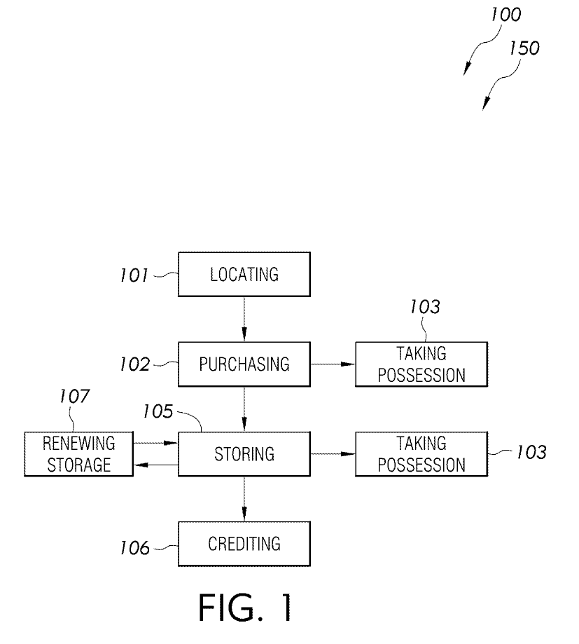

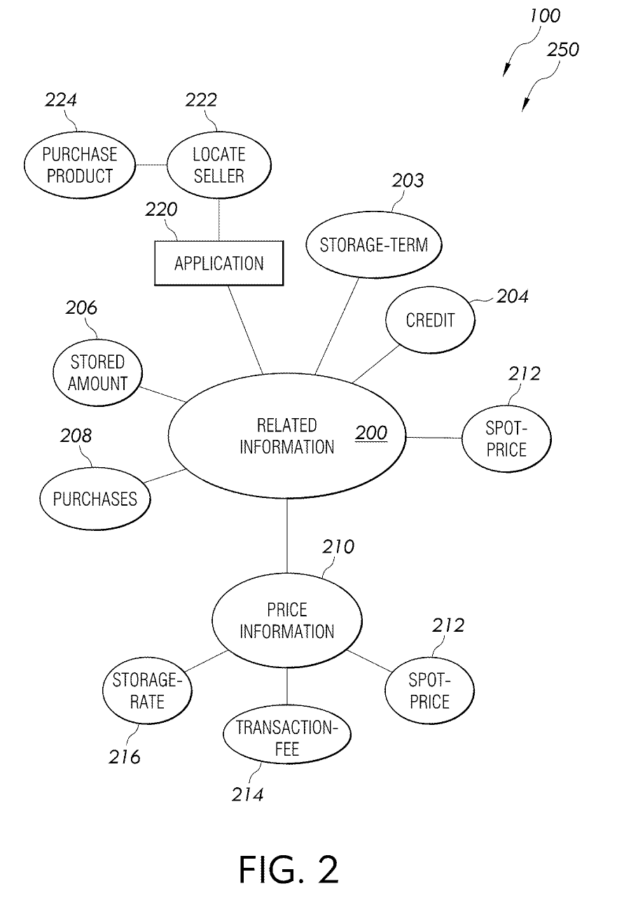

Generally speaking, the presently disclosed product pre-purchase and storage method may allow a consumer to locate and purchase a product from a seller, and store the product with a storage-owner. Referring to the drawings by numerals of reference there is shown in FIG. 1 flowchart 150 and FIG. 2 illustrating diagram 250 for product pre-purchase and storage method 100 according to an embodiment of the present disclosure. As shown in FIG. 1, product pre-purchase and storage method 100 may comprise the steps of: step one 101, a consumer locating a seller of a product; step two 102, a consumer purchasing a quantity of product, the quantity of the product comprising a plurality of incremental-portions, from seller at a initial-price; step three 103, the consumer having the option of taking possession of one of the incremental-portions of the quantity of product, leaving a remainder; step four 105, the storage-owner storing the incremental-portions of the quantity of product provided by the consumer; and step five 106, storage-owner crediting the consumer for the incremental-portions of the quantity of product provided by the consumer. Additionally, consumer may exercise an option of renewing storage 107.

Additionally, the consumer has the option of, reselling one or more of the incremental-portions of the quantity of product at spot-price 212 (FIG. 2). The reselling may occur at the end of the storage-term, and consumer may sell one or more incremental-portions of product back to seller at spot-price at the time of the reselling transaction 212.

In some embodiments, the seller and the storage-owner may be the same entity. For example, a quantity of product may be purchased by the consumer from the seller at a product-dispensing-location. Other embodiments may include a seller and a storage-owner that are different entities such that product may be purchased by one entity, and stored with/by another entity. .

Preferably, the storage-rate 216 is set by the storage-owner for the storage-term. Storage-rate 216 may be based on a value of currency for a time interval, or may be based on a value of one of incremental-portions of product for storage-term (e.g., the consumer may sell back incremental-portions of product in lieu of currency payment(s)).

Storage-rate 216 and spot-price 212 may be provided remotely to consumer from seller and/or from storage-owner, such that consumer need not be ‘on-site’ to receive the storage-rate 216 and spot-price 212. Similarly, product may be purchased and stored by consumer from seller from a remote-location. The product pre-purchase and storage method 100 may also include one or more transaction-fees such that a fee or multiple fees may be charged at each and every transaction.

In some embodiments, product may be a fuel. Other embodiments may include (but not limited to) product which may be minerals, natural resources, computer-readable data, stocks and bonds.

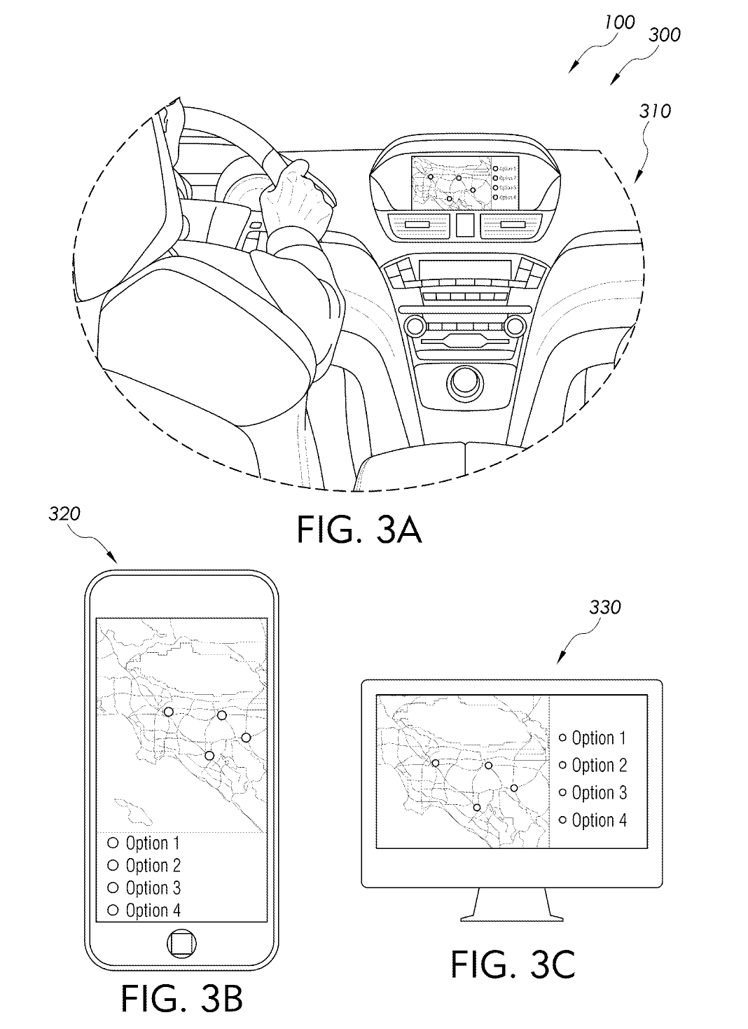

FIG. 3A illustrates the product pre-purchase and storage method 100 according to one embodiment. Here, an application 300 is shown as operable by the computer system of a vehicle 310 for the product pre-purchase and storage method 100, as described above. FIG. 3B illustrates the product pre-purchase and storage method 100 according to another embodiment. Here, application 300 is shown as operable by a mobile phone 320 for the product pre-purchase and storage method 100, as described above. FIG. 3C illustrates the product pre-purchase and storage method 100 according to yet another embodiment. Here, application 300 is shown as operable by a desktop computer 330 for the product pre-purchase and storage method 100, as described above.

Referring now to FIGS. 2, 3A, 3B and 3C illustrating product pre-purchase and storage methods 100. Consumer may locate seller of product (and storage-owner when seller and storage-owner are separate entities) via application 220. Consumer may also purchase product from seller via application 220, where application 220 may provide consumer with information related to an initial-price and said spot-price 212 (price-information 210).

Application may display related-information 200, related-information 200 may comprise incremental-portions that have been purchased by consumer, incremental-portions that have been provided to storage-owner for storage, and incremental-portions that have been sold 204 to storage-owner at spot-price 212. Related-information 200 may also include and display price information 210, such as one or more transaction-fees 214 and storage-rates 216, and may additionally provide rankings for multiple storage-owners based upon related-information 200, such that consumer may evaluate storage-owners based upon the related-information 200. Application 220 is useful for allowing consumer to locate seller 222, purchase product 224, view stored amount 206, and information related to purchases 208 as needed for consumer to make informed decisions related to purchasing and storage of product.

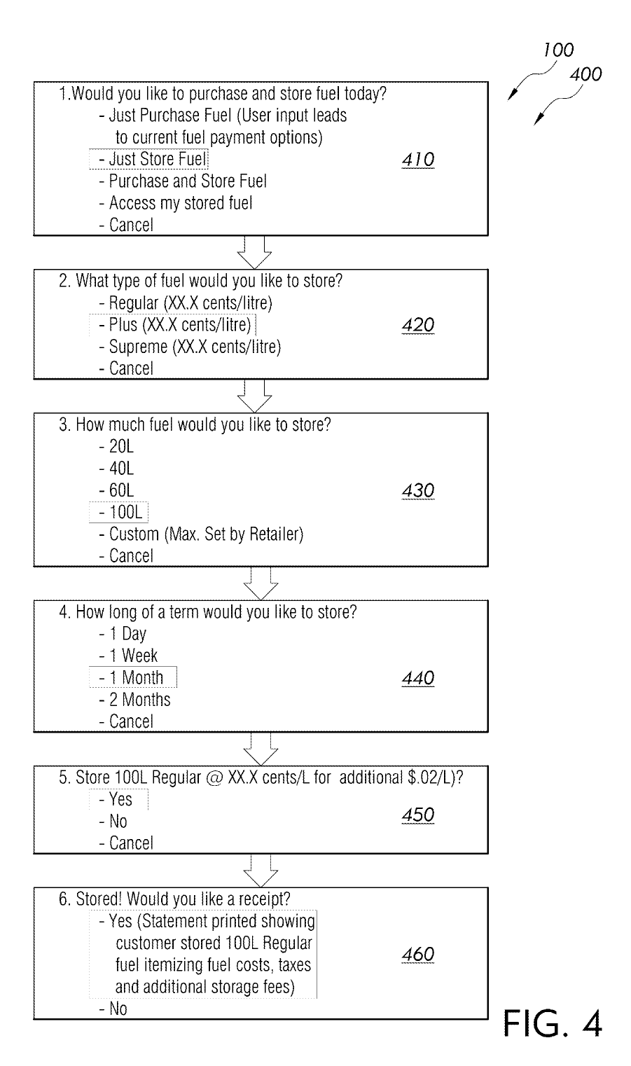

Referring now to FIG. 4, showing a decision tree for purchase and storage of fuel 400 related to product pre-purchase and storage method 100, including option to purchase and store fuel 410. The decision tree further includes option of type of fuel 420, selection of quantity of fuel 430, selection of term to store 440, amount of fuel to store 450, and optional receipt 460.

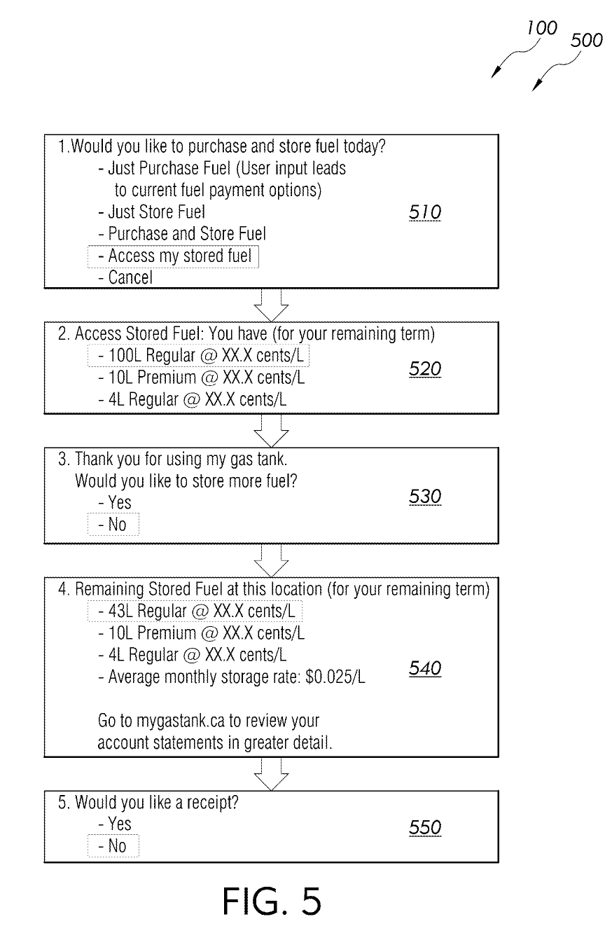

Referring now to FIG. 5 showing a decision tree for account information 500 related to product pre-purchase and storage method 100, including option to purchase and store fuel 510. The decision tree further includes access to stored fuel 520, option to store additional fuel 530, display of fuel stored 540, and optional receipt 550.

It should be noted that the steps described in the method of use can be carried out in many different orders according to user preference. The use of “step of” should not be interpreted as “step for”, in the claims herein and is not intended to invoke the provisions of 35 U.S.C. § 112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient. The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A product pre-purchase and storage method comprising the steps of:
a consumer locating a seller of a product;
said consumer purchasing a quantity of product from said seller at an initial-price, said quantity of product including a plurality of incremental-portions of said quantity of product;
said consumer having the option of taking possession of one of said incremental-portions of said quantity of product;
said consumer providing at least one of said plurality of incremental-portions of said quantity of product to a storage-owner;
said storage-owner storing the at least one of said incremental-portions of said quantity of product; and
said storage-owner crediting the consumer for the incremental-portions of the quantity of product provided by the consumer

2. The product pre-purchase and storage method of claim 1, further comprising the step of said consumer returning to take possession one or more incremental-portions of said quantity of product from said storage-owner at a later time.

3. The product pre-purchase and storage method of claim 1, further comprising the step of said consumer reselling one or more of said incremental-portions of said quantity of product at a spot-price.

4. The product pre-purchase and storage method of claim 1, wherein said seller and said storage-owner are a same entity.

5. The product pre-purchase and storage method of claim 1, wherein said seller and said storage-owner are different entities.

6. The product pre-purchase and storage method of claim 1, wherein said storage-rate is set by said storage-owner for said storage-term.

7. The product pre-purchase and storage method of claim 1, wherein said quantity of product is purchased by said consumer from said seller at a product-dispensing-location.

8. The product pre-purchase and storage method of claim 1, wherein said storage-rate and a spot-price are provided remotely to said consumer from said seller and from said storage-owner.

9. The product pre-purchase and storage method of claim 8, wherein said quantity of product is purchased and stored by said consumer from said seller from a remote-location.

10. The product pre-purchase and storage method of claim 1, further comprising the step of said consumer selling one or more of the at least one of said incremental-portions of said quantity of product back to said seller at said spot-price.

11. The product pre-purchase and storage method of claim 1, wherein said storage-rate is based on a value of currency for a time interval.

12. The product pre-purchase and storage method of claim 1, wherein said storage-rate is based on a value of one incremental-portion of said product for said storage-term.

13. The product pre-purchase and storage method of claim 1, wherein said product is a fuel.

14. The product pre-purchase and storage method of claim 1, further comprising said consumer paying one or more transaction-fees.

15. The product pre-purchase and storage method of claim 14, wherein said consumer locates said seller of said product via an application.

16. The product pre-purchase and storage method of claim 15, wherein said consumer purchases said quantity of product from said seller via said application, said application providing said consumer with information related to said initial-price and a spot-price.

17. The product pre-purchase and storage method of claim 16, wherein said application displays related-information, said related information including said plurality of incremental-portions purchased by said consumer, the at least one of said incremental-portions of said quantity of product provided to said storage-owner for storage, and any incremental-portions of said quantity of product that have been sold to said storage-owner at said spot-price.

18. The product pre-purchase and storage method of claim 16, wherein said related-information further includes said one or more transaction-fees and said storage-rate.

19. The product pre-purchase and storage method of claim 17, wherein said application further provides a ranking of multiple storage-owners based upon said related-information.

20. A product pre-purchase and storage method comprising the steps of:
a consumer locating a seller of a product;
said consumer purchasing a quantity of product from said seller at an initial-price, said quantity of product including a plurality of incremental-portions of said quantity of product;
said consumer having the option of taking possession of one of said incremental-portions of said quantity of product;
said consumer providing one of said incremental-portion of said quantity of product to a storage-owner;
said storage-owner storing the at least one of said incremental-portions of said quantity of product;
said storage-owner charging said consumer a storage-rate to store the at least one of said incremental-portions of said quantity of product for a storage-term;
said consumer returning to take possession one or more incremental-portions of said quantity of product from said storage-owner at a later time;
said consumer paying one or more transaction-fees;
wherein said seller and said storage-owner are a same entity;
wherein said storage-rate is set by said storage-owner for said storage-term;
wherein said storage-rate and a spot-price are provided remotely to said consumer from said seller and from said storage-owner;
wherein said quantity of product is purchased and stored by said consumer from said seller from a remote-location;
wherein said storage-rate is based on a value of currency for a time interval;
wherein said product is a fuel;
wherein said consumer locates said seller of said product via an application;
wherein said consumer purchases said quantity of product from said seller via said application, said application providing said consumer with information related to said initial-price and said spot-price;
wherein said application displays related-information, said related information including said plurality of incremental-portions purchased by said consumer, the at least one of said incremental-portions of said quantity of product provided to said storage-owner for storage, and any incremental-portions of said quantity of product that have been sold to said storage-owner at said spot-price;
wherein said related-information further includes said one or more transaction-fees and said storage-rate; and
wherein said application further provides a ranking of multiple storage-owners based upon said related-information.
